(19) United States
(12) Patent Application Publication
(10) Pub. No.: US 2012/0159650 A1
(43) Pub. Date: Jun. 21, 2012

(54) APPARATUS AND METHOD FOR RECOGNIZING SECURITY SITUATION AND GENERATING SITUATION INFORMATION BASED ON SPATIAL LINKAGE OF PHYSICAL AND IT SECURITY

(75) Inventors: Hyeon Koo CHO, Daejeon (KR); Beom Hwan CHANG, Daejeon (KR); Chi Yoon JEONG, Daejeon (KR)

(73) Assignee: Electronics and Telecommunications Research Institute, Daejeon (KR)

(21) Appl. No.: 13/327,334

(22) Filed: Dec. 15, 2011

(30) Foreign Application Priority Data
Dec. 17, 2010 (KR) 10-2010-0130305

(51) Int. Cl. G06F 11/00

(52) U.S. Cl. 726/34

(57) ABSTRACT

An apparatus for recognizing security situation and generating situation information based on spatial linkage of physical and IT security, the apparatus includes: a security event collection unit for mapping, when a security event is detected from a security device, unique information of the security device to a location or an object in a real space, and collecting correlated security events based on the mapped information; a security situation awareness unit for determining a type of a security situation and a degree of threat based on the correlated security events; and a situation information generation unit for analyzing a correlation between the correlated security events and the security event to generate security situation information.

### CROSS-REFERENCE(S) TO RELATED APPLICATION(S)

The present invention claims priority of Korean Patent Application No. 10-2010-0130305, filed on Dec. 17, 2010, which is incorporated herein by reference.

### FIELD OF THE INVENTION

The present invention relates to a recognition of security situation, and more particularly, to an apparatus and method for recognizing security situation and generating situation information based on spatial linkage of physical and information technology (IT) security, which map a security event generated in a physical or logical space to a real space to thereby recognize a security situation based on a generation time and generation location of the security event and to create space-based situation information.

### BACKGROUND OF THE INVENTION

In recent industrial environment in which human beings, information, infrastructure, system, and the like are organically bound, physical space and cyber space coexist. Threats against information assets in such an industrial environment involve leakage through mobile storage media or physical break-in by an intruder, or leaking information by hacking, worm virus and malicious bot in the cyber space. Therefore, fragmentary technologies such as an existing physical security and an IT security technology alone cannot prevent the leak of the assets.

To protect the information assets of the industrial facilities, therefore, the technology of organically integrating physical space (work space) and the logical space (cyber space) to detect and prevent security violation accidents is needed.

In order to meet the needs for the security technology, the technology of monitoring and controlling the access to the physical space and cyber space using an integrated authentication card (smart card) has been developed as one of the convergence security technologies converging the IT security and physical security. However, it has a problem of having to change all the existing infrastructures.

Further, there are methods of monitoring the user activities in the logical and physical spaces to detect the security violation by interworking with an identity management (IdM) system, in order to detect the security violation by collecting the security events from various sensors of the access control system, network security equipment, or the like in the physical and cyber spaces, analyzing the correlation therebetween. However, these methods are the ones that simply interface the physical security technology and IT security technology, or that analyze event correlations and detect the security violation through syntax-based formalization of various security sensor events.

Such methods remain merely monitoring the security situation based on the virtual spatial information and are considered to be inadequate to timely alarm the security violation and promptly and accurately perform the countermeasures by recognizing the security situation based on the actual spatial information of the business environment and creating the spatial correlation-based situation information for space-time analysis.

### SUMMARY OF THE INVENTION

In view of the above, the present invention provides an apparatus and method for recognizing security situation and generating situation information based on spatial linkage of physical and IT security, which can recognize a security situation based on a generation time and generation location of a security event generated in a physical or logical space by mapping the security event to a real space, thereby creating space-based situation information.

In accordance with an aspect of the present invention, there is provided an apparatus for recognizing security situation and generating situation information based on spatial linkage of physical and IT security, the apparatus including:

a security event storage unit for storing security events generated from multiple security devices installed in a physical or logical space, each of the security devices having its own unique information;

a spatial information storage unit for storing locations or object information of a real space in which the multiple security devices are installed.

a security event collection unit for mapping, when a security event is detected from one of the multiple security devices, unique information of said one of the security devices to a location or an object in the real space stored in the spatial information storage unit, and collecting correlated security events, related to the detected security event, from the security event storage unit based on the mapped information;

a security situation awareness unit for determining, if the detected security event corresponds to a security situation, a type of the security situation and a degree of threat based on the correlated security events and predefined security situation criteria; and

a situation information generation unit for analyzing a correlation, based on the type of the security situation, between the correlated security events and the detected security event to generate security situation information.

In accordance with another aspect of the present invention, there is provided a method for recognizing security situation and generating situation information based on spatial linkage of physical and IT security, in a security system including a security event storage unit for storing security events generated from multiple security devices having unique information installed in a physical space or logical space, and a spatial information storage unit for storing locations or object information of a real space in which the multiple security devices are installed, the method comprising:

receiving a message indicating that a security event has been detected from one of the multiple security devices;

collecting, from the security event storage unit, correlated security events related to the detected security event;

determining, if the detected security event is abnormal and corresponds to a security situation, a type of the security situation and a degree of threat based on the correlated security events and predefined security situation criteria; and

analyzing, based on the type of the security situation, a correlation between the correlated security events and the detected security event to generate security situation information.

### BRIEF DESCRIPTION OF THE DRAWINGS

The objects and features of the present invention will become apparent from the following description of embodiments, given in conjunction with the accompanying drawings, in which:

FIG. 1 is block diagram illustrating a system for recognizing security situation and generating situation information based on spatial linkage of physical and IT security in accordance with an embodiment of the present invention;

FIG. 2 is a block diagram showing an internal configuration of a security situation information generation server in accordance with the embodiment of the present invention; and

FIG. 3 is a flowchart illustrating a process of recognizing a security situation and generating situation information in accordance with the embodiment of the present invention.

### DETAILED DESCRIPTION OF THE EMBODIMENT

Hereinafter, embodiments of the present invention will be described with reference to the accompanying drawings which form a part hereof.

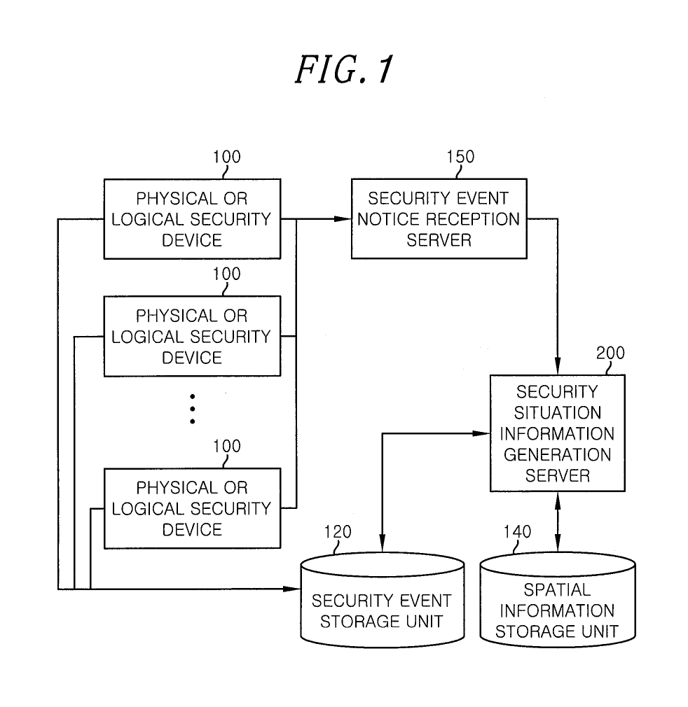

FIG. 1 is a block diagram illustrating a system for recognizing security situation and generating situation information based on spatial linkage of physical and IT security in accordance with an embodiment of the present invention. The system includes multiple physical or logical security devices 100, a security event storage unit 120, a spatial information storage unit 140, a security event notice reception server 150, and a security situation information generation server 200.

The physical or logical security devices 100 are installed in the physical or logical space and store security events in the security event storage unit 120 when the security events occur. As for examples of the physical or logical security devices 100, there may be an access control system, radio frequency identification (RFID), global positioning system (GPS), a temperature/humidity sensor, a motion detecting sensor, a network intrusion detection/prevention system (IDS/IPS), a firewall, a system log, traffic analysis, information asset surveillance system, data loss prevention system (DLP), and the like.

Such physical or logical security devices 100 provide a notice message indicating the occurrence of a security event to the security event notice reception server 150. Here, the notice message contains its unique information, e.g., identification (ID) information.

The security event storage unit 120 stores security events received from the physical or logical security devices 100. A security event contains event generation time, an installation location of the physical or logical security devices 100, ID information of a physical or logical security device 100 that has generated the security event, and the like.

The spatial information storage unit 140 stores real spatial information, i.e., locations or object information of a real space in which the physical or logical security devices 100 are installed.

The security event notice reception server 150 receives the notice message indicating the occurrence of a security event from a specific physical or logical security device 100 and creates a security event reception message to send it to the security situation information generation server 200. Here, the security event reception message contains information on the security event, ID information and location information of the physical or logical security device 100 that has generated the security event, and the like.

The security situation information generation server 200 extracts real spatial information from the spatial information storage unit 140 based on the location information of the specific physical or logical security device 100, and collects security events correlated with a generated security event by searching the security event storage unit 120 based on the extracted real spatial information and the security event generation time. In other words, among security events generated from physical or logical security devices 100 installed in the same location as the specific physical or logical security device 100 or in a space within a predetermined radius of the specific physical or logical security device 100, security events correlated with security events generated from the specific physical or logical security device 100 are searched and collected.

Next, the security situation information generation server 200 integrates the collected security events to verify the security situation. It also recognizes a type of security situation to create situation information and provide the created situation information to the user through a real space-based situation map.

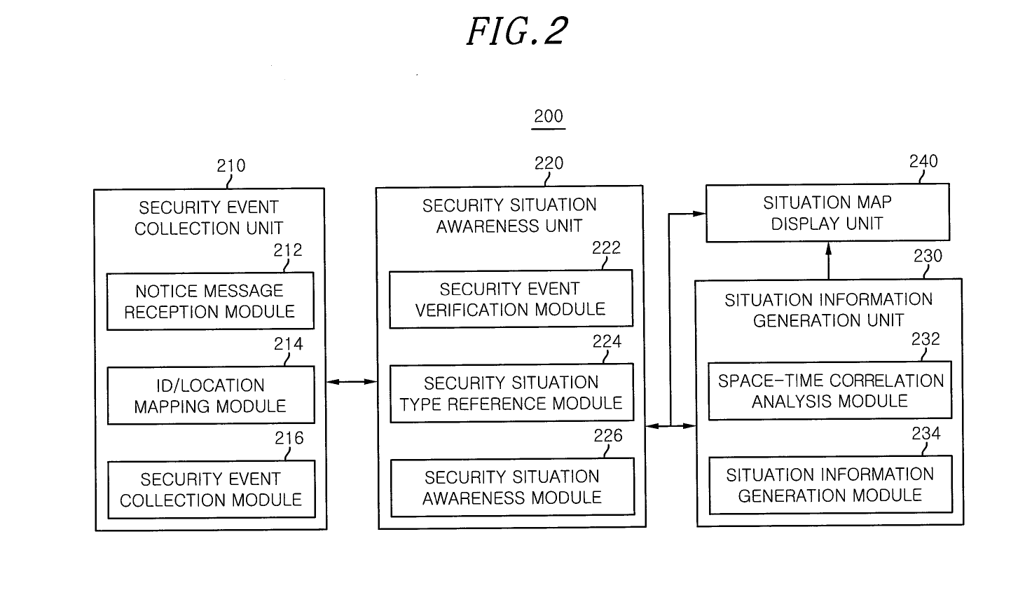

To this end, as shown in FIG. 2, the security situation information generation server 200 includes a security event collection unit 210, a security situation awareness unit 220, a situation information generation unit 230, and a situation map display unit 240.

The security event collection unit 210 includes a notice message reception module 212, an ID/location mapping module 214 and a security event collection module 216.

The notice message reception module 212 receives the security event reception message sent from the security event notice reception server 150 to extract, from the security event reception message, the security event generation time and the ID information of the physical or logical security device 100 that has generated the security event. The ID/location mapping module 214 maps the ID information to a location or an object in the real space. The security event collection module 216 collects, from the security event storage unit 120, correlated security events in the same location or space as an installation location of the physical or logical security device 100 by using the mapped location or object information.

The security situation awareness unit 220 includes a security event verification module 222 for verifying whether the security event is normal based on the correlated security events and the generation location information of the security event, a security situation type reference module 224 for referring to security situation criteria defined to acknowledge security situations of abnormal security events, and a security situation awareness module 226 for determining a validity a of a security situation, a type thereof and a degree of threat based on correlated security events of an abnormal security event and an security situation criterion referred according to the abnormal security event.

The situation information generation unit 230 includes a space-time correlation analysis module 232 for analyzing a space-time correlation between the correlated security events and the generated security event based on the type of the security situation, and a situation information generation module 234 for generating security situation information that contains real space information, a type of security situation and threat details based on the analyzed space-time correlation.

The situation map display unit 240 displays business/security sections and personnel/asset object information on an electronic map of a business/facility site, and visualizes the acknowledged and generated security situation and its details such that the user, e.g., a security officer can intuitively recognize them.

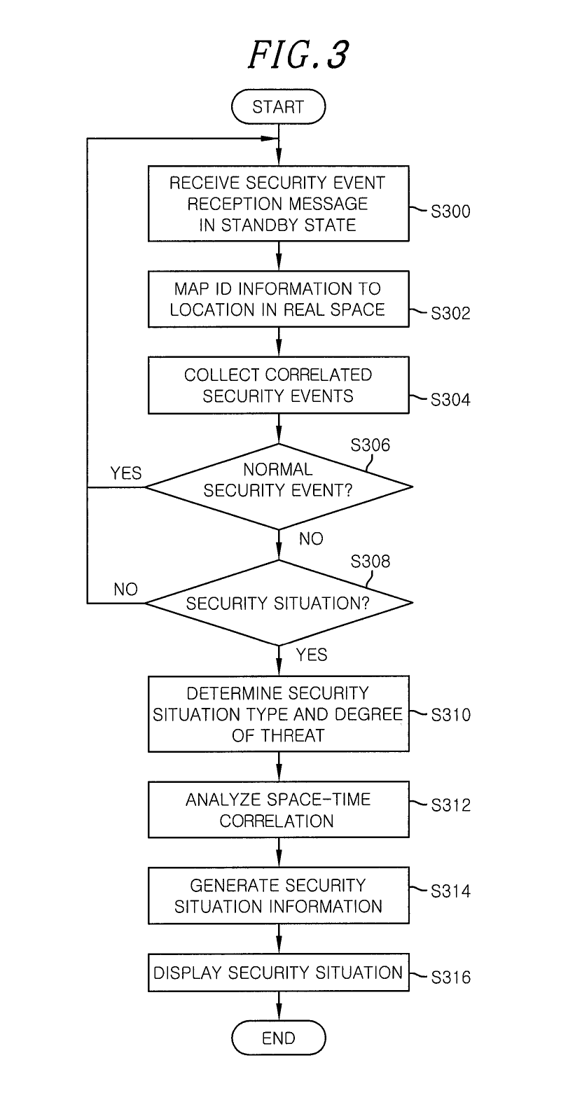

FIG. 3 is a flowchart illustrating a process in which the security situation information generation server recognizes security situation and generates security situation information in the event of a security event in accordance with the embodiment of the present invention.

As shown in FIG. 3, when a security event is generated from a physical or logical security device 100, the notice message reception module 212 of the security situation information generation server 200 in a standby state receives a security event reception message from the security event notice reception server 150 in step S300. A time at which the security event has been generated and ID information of the physical or logical security device 100 are extracted from the received security event reception message.

Next, the ID/location mapping module 214 maps the ID information of the physical or logical security device 100 that has generated the security event to a location in the real space stored in the spatial information storage unit 140 in step S302.

Thereafter, the security event collection module 216 collects, from the security event storage unit 120, correlated security events in the same location or space as that of the physical or logical security device 100 by using the mapped location information in step S304. In detail, the security event collection module 216 searches the security event storage unit 120 for security events in the same generation time range among security events generated from a physical or logical security device 100 existing in the mapped location information to thereby collect the correlated security events. The thus collected correlated security events and the generated security event are provided to the security situation awareness unit 220.

The security event verification module 222 of the security situation awareness unit 220 verifies whether the provided security event is normal or not based on the correlated security events and information on the location at which the security event has been generated in step S306. For example, if the security event has been generated by access of a security officer who checks the security status, and the correlated security events have also been generated by the access of the security officer, this security event can be verified to be normal.

As a result of the verification in step S306, if the security event is normal, the process proceeds to step S300 to enter the standby state for receiving a security event reception message. Otherwise, the security situation awareness module 226 determines whether a current situation corresponds to a security situation based on the security situation criteria defined in the security situation type reference module 224 and the abnormal security events in step S308.

If it is determined as a security situation in step S308, the security situation awareness module 226 determines a security situation type, a degree of threat and the like depending on the abnormal security events and the security situation criteria in step S310. The determined security situation type and degree of threat are provided to the situation information generation unit 230.

The space-time correlation analysis module 232 of the situation information generation unit 230 analyzes the space-time correlation between the correlated security events and the generated security event based on the security situation type in step S312 to provide the result to the situation information generation module 234.

The situation information generation module 234 generates security situation information that includes real space information, the security situation type and threat details based on the analyzed correlation in step S314, and provides the generated security situation information to the situation map display unit 240.

The situation map display unit 240 displays the business/security sections and personnel/asset object information on an electronic map of a business/facility site within the location and space where the security event has been generated, and visualizes the generated security situation information and the displayed information such that the security officer can intuitively recognize them in step S316.

In accordance with the embodiment of the present invention, in various industrial environments where the human beings, information, infrastructure, system, and the like are organically bounded, security situation is recognized through spatial linkage analysis by mapping a security event detected in a physical or logical security space to a physical object or business domain in a real space based on a generation location of the security event, and security situation information is generated to be displayed on a situation map, thereby enabling a security officer to intuitively recognize the security situation. Also, various security situations are recognized more accurately and timely, so that the real-time response depending on the situation can be achieved, as compared to individual security environment or simple physical/logical integrated security environment.

Further, in accordance with the embodiment of the present invention, a security event is mapped with real space information by using a generation location of the security event, and correlation therebetween is analyzed in order to link the securities in the physical space and logical space. Thus, it can minimize changes of the infrastructure and architecture of the existing security systems and can effectively monitor and respond to the security situations occurring around the information assets of industrial facilities having a limited specific space by monitoring security events based on real spatial information by means of multiple security sensors.

While the invention has been shown and described with respect to the embodiments, it will be understood by those skilled in the art that various changes and modification may be made without departing from the scope of the invention as defined in the following claims.

What is claimed is:

1. An apparatus for recognizing security situation and generating situation information based on spatial linkage of physical and IT security, the apparatus comprising:
a security event storage unit for storing security events generated from multiple security devices installed in a physical or logical space, each of the security devices having its own unique information;
a spatial information storage unit for storing locations or object information of a real space in which the multiple security devices are installed.
a security event collection unit for mapping, when a security event is detected from one of the multiple security devices, unique information of said one of the security devices to a location or an object in the real space stored in the spatial information storage unit, and collecting correlated security events, related to the detected security event, from the security event storage unit based on the mapped information;
a security situation awareness unit for determining, if the detected security event corresponds to a security situation, a type of the security situation and a degree of threat based on the correlated security events and predefined security situation criteria; and
a situation information generation unit for analyzing a correlation, based on the type of the security situation, between the correlated security events and the detected security event to generate security situation information.

2. The apparatus of claim 1, wherein the security event collection unit includes:
a notice message reception module for receiving, when the security event is detected, a message indicating the detection of the security event to extract a generation time of the detected security event and the unique information of said one of the security devices within the message;
an ID/location mapping module for mapping the extracted unique information to the location or the object in the real space stored in the spatial information storage unit; and
a security event collection module for collecting correlated security events in the same location or space as an installation location of said one of the security devices by searching the security event storage unit based on the mapped information.

3. The apparatus of claim 2, wherein the security event collection module collects the correlated security events by searching the security event storage unit based on the generation time and generation location of the detected security event.

4. The apparatus of claim 1, wherein the security situation awareness unit includes:
a security event verification module for verifying whether the detected security event is normal or not based on the correlated security events and a generation location of the detected security event;
a security situation type reference module for referring to the predefined security situation criteria to recognize the security situation of the detected security event; and
a security situation awareness module for determining a validity of the security situation, the type thereof and the degree of threat depending on the security situation criteria referred to by the security situation type reference module and the correlated security events.

5. The apparatus of claim 1, wherein the situation information generation unit includes:
a space-time correlation analysis module for analyzing a space-time correlation between the correlated security events and the detected security event depending on the type of the security situation; and
a situation information generation module for generating security situation information that includes real space information, the type of the security situation and threat details based on the space-time correlation.

6. The apparatus of claim 1, further comprising:
a situation map display unit for displaying business/security sections and personnel/asset object information on a location or a space corresponding to generation location of the detected security event, and providing the generated security situation information to a security officer.

7. A method for recognizing security situation and generating situation information based on spatial linkage of physical and IT security, in a security system including a security event storage unit for storing security events generated from multiple security devices having unique information installed in a physical space or logical space, and a spatial information storage unit for storing locations or object information of a real space in which the multiple security devices are installed, the method comprising:
receiving a message indicating that a security event has been detected from one of the multiple security devices;
collecting, from the security event storage unit, correlated security events related to the detected security event;
determining, if the detected security event is abnormal and corresponds to a security situation, a type of the security situation and a degree of threat based on the correlated security events and predefined security situation criteria; and
analyzing, based on the type of the security situation, a correlation between the correlated security events and the detected security event to generate security situation information.

8. The method of claim 7, wherein said collecting the correlated security events includes:
extracting a generation time of the detected security event and unique information of said one of the security devices from the message;
mapping the extracted unique information to a location or an object in the real space stored in the spatial information storage unit; and
collecting correlated security events in the same location or space as an installation location of said one of the security devices by searching the security event storage unit based on the mapped information.

9. The method of claim 8, wherein the correlated security events are collected by searching the security event storage unit based on the generation time and generation location of the detected security event.

10. The method of claim 7, wherein said determining the type of the security situation and the degree of threat includes:
verifying whether the detected security event is normal or not based on the correlated security events and generation location of the detected security event;
referring to the predefined security situation criteria to recognize the security situation of the detected security event, when the detected security event is abnormal; and
determining a validity of the security situation, the type thereof and the degree of threat depending on the referred security situation criteria and the correlated security events.

11. The method of claim 7, wherein said analyzing the correlation includes:
analyzing a space-time correlation between the correlated security events and the detected security event depending on the type of the security situation; and
generating security situation information that includes real space information, the type of the security situation and threat details based on the space-time correlation.

12. The method of claim 7, further comprising:
displaying business/security sections and personnel/asset object information on a location or a space corresponding to the generation location of the detected security event, and providing the generated security situation information to a security officer.
